(19) United States
(12) Patent Application Publication
(10) Pub. No.: US 2006/0266865 A1
(43) Pub. Date: Nov. 30, 2006

(54) Seatbelt Retractor and Seatbelt Apparatus Using the Same

(75) Inventors: Koji TANAKA, Tokyo (JP); Koji INUZUKA, Tokyo (JP)

Correspondence Address: FITCH EVEN TABIN AND FLANNERY, 120 SOUTH LA SALLE STREET, SUITE 1600, CHICAGO, IL, 60603-3406, US

(73) Assignee: TAKATA CORPORATION, Tokyo (JP)

(21) Appl. No.: 11/419,674

(22) Filed: May 22, 2006

(30) Foreign Application Priority Data
May 27, 2005 (JP) 2005-155454

(51) Int. Cl. B60R 22/46

(52) U.S. Cl. 242/374

(57) ABSTRACT

A motor-driven seatbelt retractor is provided in which generation of an operation noise of a power transmission mechanism can be minimized when the power transmission mechanism is operated. In one form, in a power transmission gear mechanism, a gear which is in the proximity of a cover is supported on a revolving shaft so as to be capable of rotating integrally therewith, while it can be moved in a direction of an axis of the revolving shaft. A ring-shaped stopper is fitted to an annular groove provided on the revolving shaft on the cover side with respect to the gear so as not to be capable of moving in the direction of the axis of the revolving shaft. The stopper prevents the axial movement of the gear toward the cover during rotation of the gear and hence the gear does not come into contact with the cover. A space is formed between an opposing end of the revolving shaft and the cover, and with this space, the revolving shaft is prevented from coming into contact with the cover.

### FIELD OF THE INVENTION

The present invention relates to a technical field of a seatbelt retractor provided on a vehicle such as a motor vehicle for retracting a seatbelt to constrain and protect a passenger by transmitting a drive torque of a motor to a spool via a power transmission mechanism and a seatbelt apparatus using the same.

### BACKGROUND OF THE INVENTION

A seatbelt apparatus provided on a vehicle such as a motor vehicle constrains the passenger by a seatbelt in case of emergency such as collision where a large deceleration is applied to a vehicle, thereby preventing a passenger from jumping out from a seat and protecting the passenger. The seatbelt apparatus is provided with a seatbelt retractor which constantly urges a spool for retracting the seatbelt in the belt retracting direction and prevents the seatbelt from being withdrawn by activating an emergency locking mechanism (ELR mechanism) upon emergency described above and locking rotation of the spool in the withdrawing direction.

As a seatbelt retractor as described above, a motor retractor that retracts and withdraws the seatbelt by rotating the spool by the drive torque of the motor is proposed in the related art (for example, see Japanese Unexamined Patent Application Publication No. 2005-35485). According to the motor retractor in this type, since a tensile force of the seatbelt can be controlled by retracting the seatbelt by the motor, a wearing mode of the seatbelt can be set variously and hence constraint of the passenger by the seatbelt can be more suitably and meticulously according to a traveling state or the like of the vehicle.

The motor retractor disclosed in Japanese Unexamined Patent Application Publication No. 2005-35485 employs a power transmission gear mechanism having a predetermined number of gears as a power transmission mechanism for transmitting the drive torque of the motor to the spool. By covering the power transmission gear mechanism with a cover, foreign substances are prevented from coming into contact with or entering into the power transmission gear mechanism from the outside or entering between the gears that mesh with each other, and an operation noise which is generated when the power transmission gear mechanism is operated is constrained from leaking outside.

The motor retractor disclosed in Japanese Unexamined Patent Application Publication No. 2005-35485 is not provided with spring means which is provided in conventional non-motor driven seatbelt retractors for retracting the seatbelt when the seatbelt is not worn. A motor retractor having such the spring means is also proposed (for example, see Japanese Unexamined Patent Application Publication No. 2005-53422).

The motor retractor disclosed in Japanese Unexamined Patent Application Publication No. 2005-53422 employs the power transmission gear mechanism having a predetermined number of gears as the power transmission mechanism for transmitting the drive torque of the motor to the spool, and is provided with the cover for covering the power transmission gear mechanism for the same object as Japanese Unexamined Patent Application Publication No. 2005-35485.

However, with the motor retractor in the related art as described above, although leakage of the operation noise generated by the power transmission gear mechanism to the outside is retrained by covering with the cover, generation of the operation noise of the power transmission gear mechanism by itself cannot be restrained.

For example, in the case of both of the power transmission gear mechanisms disclosed in Japanese Unexamined Patent Application Publication No. 2005-35485 and Japanese Unexamined Patent Application Publication No. 2005-53422, a gear a is supported on a revolving shaft b so as to be capable rotating integrally therewith as shown in FIG. 4. However, since the gear a is adapted to be capable of moving until it comes into abutment with a cover c, the gear a comes into contact with the cover c and hence hits the cover c while being rotated, and the hitting sound is propagated over the entire cover c and leaked toward the outside, which may cause a noise. In other words, there is a possibility that with the provision of the cover c, the sound to hit the cover c by the gear a may become the operation noise of the power transmission gear mechanism.

Normally, in order to prevent the gear a from coming apart from the revolving shaft b, the revolving shaft b is provided so as to come into contact with the cover c at a distal end b₁ thereof. In this case, the cover 9 cannot be moved, while a revolving shaft 12 can be moved (rotated). Therefore, a frictional sound may be generated as the operation noise of the power transmission gear mechanism between the cover 9 and the revolving shaft 12 during rotation of the revolving shaft 12.

### SUMMARY OF THE INVENTION

In view of such circumstances, it is an object of the present invention to provide a motor-driven seatbelt apparatus in which generation of the operation noise of a power transmission mechanism can be minimized when the power transmission mechanism is operated, and a seatbelt apparatus using the same.

In order to solve the above-described problem, a seatbelt retractor according to a first form includes at least includes a spool for retracting a seatbelt, a motor for generating a drive torque for rotating the spool, a power transmission mechanism for transmitting the drive torque of the motor to the spool, a cover for covering the power transmission mechanism, and operation noise restraint for restraining generation of an operation noise when the power transmission mechanism is operated.

The seatbelt retractor according to a second form of the present invention is characterized in that the power transmission mechanism is a power transmission gear mechanism having a gear, and the operation noise generation restraint is a space set between the cover and a revolving shaft that supports the gear so as to be capable of rotating integrally therewith for preventing the revolving shaft from coming into abutment with the cover.

The seatbelt retractor according to a third form of the present invention is characterized in that the power transmission mechanism is the power transmission gear mechanism having the gear and the revolving shaft that supports the gear so as to be capable of rotating integrally therewith is provided with a movement preventing device for preventing the gear from moving in the direction of an axis of the revolving shaft for avoiding abutment between the gear and the cover, and the movement preventing device is the operation noise generation restricting device.

The seatbelt retractor according to a fourth form of the present invention is characterized in that the movement preventing device includes a groove provided on the revolving shaft and a ring-shaped stopper fitted to the groove.

A seatbelt apparatus according to a fifth form of the present invention at least includes a seatbelt for constraining a passenger, a seatbelt retractor for retracting the seatbelt so as to be capable of being withdrawn, a tongue supported by the seatbelt so as to be capable of sliding, and a buckle provided on a vehicle body or a vehicle seat so that the tongue can be engaged with, and is characterized in that the seatbelt retractor is the seatbelt retractor according to any one of the first to third forms.

With the seatbelt retractor according to the first to fourth forms configured as described above, since the operation noise restraint is provided, generation of the operation noise when the power transmission mechanism is operated can effectively be restrained. In addition, by combining a leakage restraining function of the cover for restraining leakage of the operation noise of the power transmission gear mechanism toward the outside, noise caused by leakage of the operation noise of the power transmission gear mechanism toward the outside can be restrained further effectively.

In particular, with the seatbelt retractor according to the second form of the present invention, since the operation noise generation restraint is composed of a space provided between the cover and the revolving shaft that supports the gear, the revolving shaft can be prevented from coming into contact with the cover. Accordingly, generation of a frictional sound of the revolving shaft with respect to the cover during rotation of the revolving shaft can be prevented, and hence the operation noise of the power transmission gear mechanism can be prevented effectively. In addition, since the operation noise restraint is composed of the simple space, the structure can be simplified.

With the seatbelt retractor according to the third and fourth forms of the present invention, since the movement preventing device for preventing movement of the gear in the direction of the axis of the revolving shaft for preventing abutment of the gear with the cover, the gear can be prevented from coming into contact with the cover during rotation thereof. Accordingly, generation of sound of hitting the cover by the gear can be prevented, and hence the operating noise can be effectively restrained.

Furthermore, with the invention according to the fourth form, since the movement preventing means includes the groove on the revolving shaft and the ring-shaped stopper fitted in the groove, the movement preventing device can be simplified.

In addition, according to the seatbelt apparatus in the fifth form of the present invention, since the seatbelt retractor according to any one of the first to fourth forms is employed as the seatbelt retractor, the operation noise of the power transmission gear mechanism of the seatbelt retractor can be restrained even when it is operated, whereby a cabin can be a comfortable space during the drive of the vehicle.

### BRIEF DESCRIPTION OF THE DRAWINGS

FIG. 1 is a sketch drawing showing an example of an embodiment of a seatbelt retractor according to the present invention.

FIG. 2 is a partially enlarged cross-sectional view showing part of a power transmission mechanism in the seatbelt retractor in the example shown in FIG. 1 in an enlarged scale.

FIG. 3 is a sketch drawing showing an example of a seatbelt apparatus using the seatbelt retractor in the example shown in FIG. 1.

FIG. 4 is a partially enlarged cross-sectional view like FIG. 2 for explaining drawbacks of a power transmission gear mechanism in a motor retractor in the related art.

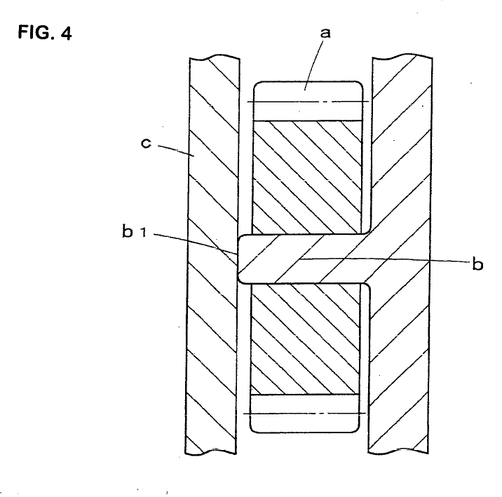

### DETAILED DESCRIPTION OF THE PREFERRED EMBODIMENTS

Referring now to the drawings, a best mode for carrying out the present invention will be described.

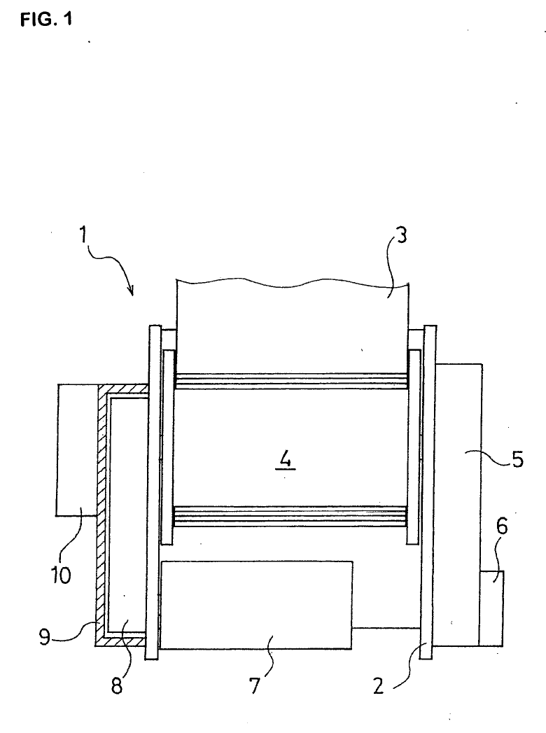

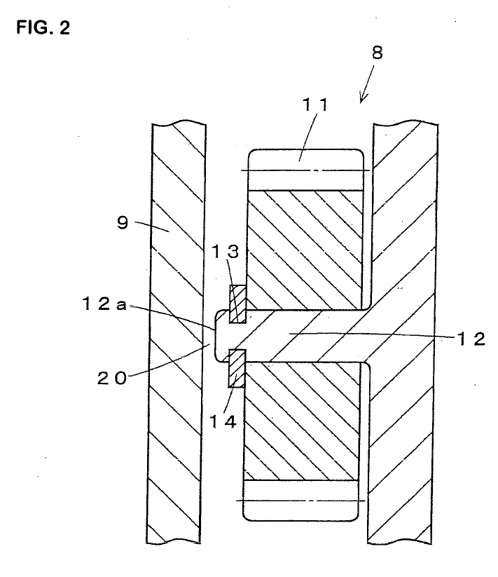

FIG. 1 is a sketch drawing showing an example of an embodiment of a seatbelt retractor according to the present invention. FIG. 2 is a partially enlarged cross-sectional view showing part of a power transmission mechanism in the seatbelt retractor in this example in an enlarged scale.

As shown in FIG. 1, a seatbelt retractor 1 in this example roughly includes a frame 2, a seatbelt 3 that constrains a passenger when needed, a spool 4 that retracts the seatbelt 3 so as to be capable of being withdrawn, locking device 5 as an ELR mechanism that is provided on one side of the frame 2 and is activated upon a significant deceleration exceeding predetermined deceleration such as a collision and prevents rotation of the spool 4 in a belt withdrawing direction, deceleration sensing means (vehicle sensor) 6 that is activated when deceleration exceeding a predetermined value is applied to a vehicle to activate the locking device 5, a motor 7 that generates a drive torque to be applied to the spool 4, a power transmission gear mechanism (corresponding to the power transmission mechanism of the present invention) 8 that reduces the speed of the drive torque of the motor 7 and transmits the same to the spool 4, a cover 9 fixed to the frame 2 for covering the power transmission gear mechanism 8, and spring member 10 for constantly urging the spool 4 in a retracting direction.

The frame 2, the seatbelt 3, the spool 4, the locking device 5, the deceleration sensing means (vehicle sensor) 6, the motor 7, the cover 9 and the spring member 10 are all the same as those in Japanese Unexamined Patent Application Publication No. 2005-53422 described above. As shown in FIG. 2, the power transmission gear mechanism 8 is the same of the power transmission gear mechanism in Japanese Unexamined Patent Application Publication No. 2005-53422 other than a portion shown in FIG. 2.

In other words, as shown in FIG. 2, in the power transmission gear mechanism 8 in this example, a gear 11 which is in the proximity of the cover 9 is supported on a revolving shaft 12 so as to be capable of rotating integrally therewith, while it can be moved in an axial direction of the revolving shaft 12. The gear 11 in the proximity of the cover 9 means the gear that can come into contact with the cover 9 during rotation.

The revolving shaft 12 is formed with an annular groove 13, and a ring-shaped stopper 14 is fitted to the annular groove 13 on the cover 9 side with respect to the gear 11 so as not to be capable of moving in the axial direction of the revolving shaft 12 and rotatable integrally with the revolving shaft 12. The stopper 14 may be a snap ring which is known in the related art, but is not limited thereto. With the provision of the stopper 14, movement of the gear 11 in the axial direction of the revolving shaft 12 is prevented, so that the gear 11 does not come in contact with the cover 9 during rotation. A movement preventing device or operation noise generation restraint of the present invention are constituted by the provision of the groove 13 and the stopper 14.

Formed between a distal end of the revolving shaft 12, that is, between an opposing end 12a opposing to the cover 9 and the cover 9 is a space (clearance) 20, and the space 20 prevents the opposing end 12a of the revolving shaft 12 from coming into contact with the cover 9. The operation noise generation restraint of the present invention is constituted by the space 20.

According to the seatbelt retractor 1 in this example that is configured as described above, since the stopper 14 fitted to the groove 13 of the revolving shaft 12 so as not to be moved in the axial direction, when the power transmission gear mechanism 8 is operated and hence the gear 11 is rotated, the axial movement of the gear 11 toward the cover 9 can be prevented by the stopper 14. Accordingly, the gear 11 can be prevented from coming into contact with the cover 9 during its rotation, and hence generation of sound to hit the cover 9 by the gear 11 can be prevented. Consequently, the operation noise of the power transmission gear mechanism 8 can effectively be prevented. In addition, by combining a leakage restraining function of the cover 9 for restraining leakage of the operation noise of the power transmission gear mechanism 8 toward the outside, the operation noise of the power transmission gear mechanism 8 toward the outside can be shut down further effectively.

Since the axial movement of the gear 11 toward the cover 9 is prevented with the groove 13 on the revolving shaft 12 and the ring-shaped stopper 14 fitted to the groove 13, the movement preventing device can be achieved in a simple structure.

In addition, since the operation noise generation restraint is configured by the space 20 provided between the cover 9 and the opposing end 12a of the revolving shaft 12, the revolving shaft 12 is prevented from coming into contact with the cover 9. Accordingly, generation of the frictional sound of the revolving shaft 12 with respect to the cover 9 during rotation of the revolving shaft 12 can be prevented, and hence the operation noise of the power transmission gear mechanism 8 can be prevented effectively. In addition, since the operation noise generation restraint is composed of the simple space 20, the structure can be simplified.

The seatbelt retractor 1 can be applied to the seatbelt retractor 1 employed in the seatbelt apparatus known in the related art.

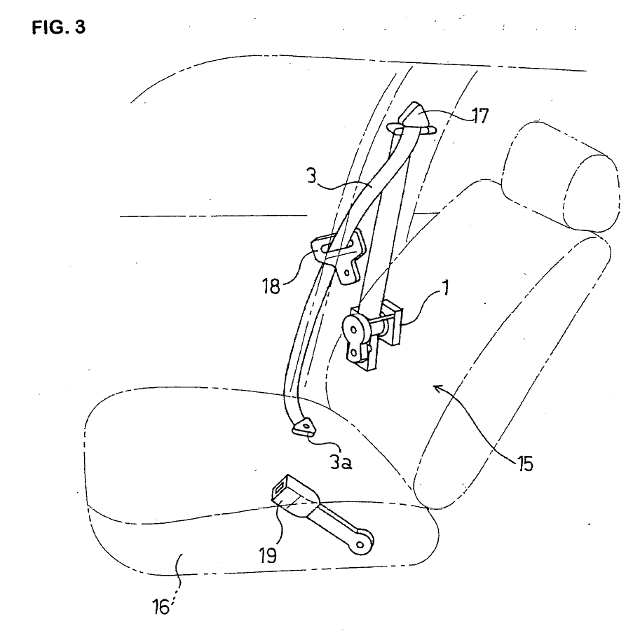

FIG. 3 is a sketch drawing showing an example of the seatbelt apparatus using the seatbelt retractor in this example.

As shown in FIG. 3, a seatbelt apparatus 15 in this example includes the seatbelt retractor 1 in this example fixed to a vehicle body, the seatbelt 3 to be withdrawn from the seatbelt retractor 1 and to be fixed to a floor of the vehicle body or a vehicle seat 16 via a belt anchor 3a at a distal end thereof, a guide anchor 17 for guiding the seatbelt 3 withdrawn from the seatbelt retractor 1 to a shoulder of the passenger, a tongue 18 supported by the seatbelt 3 guided from the guide anchor 17 so as to be capable of sliding movement, and a buckle 19 which is fixed to the floor of the vehicle body or the vehicle seat and which the tongue 18 is inserted in and engaged with so as to be capable of engagement and disengagement.

The effects and advantages of the seatbelt apparatus 15 in this example is the same as the effects and advantages of the seatbelt apparatus 1 described above, and the effects and advantages of other parts are the same as the effects and advantages of the seatbelt apparatus known in the related art.

According to the seatbelt apparatus 15 in this example, since the seatbelt retractor 1 in this example is used, the operation noise can be restrained even when the power transmission gear mechanism 8 of the seatbelt retractor is operated, whereby a cabin can be a comfortable space during the drive of the vehicle.

In the example described above, the movement preventing device of the gear 11 is composed of the annular groove 13 and the ring-shaped stopper 14. However, instead of the groove 13 and the stopper 14, it may be composed of a radial hole provided on the revolving shaft 12 and a pin to be fitted into the radial hole.

In the example described above, the power transmission gear mechanism disclosed in Japanese Unexamined Patent Application Publication No. 2005-53422 is employed as the power transmission gear mechanism 8. However, it not limited thereto, and may be any known power transmission gear mechanism, for example, the power transmission gear mechanism disclosed in Japanese Unexamined Patent Application Publication No. 2005-35485 as long as they are the power transmission gear mechanism that can be applied to the motor retractor. Furthermore, the power transmission mechanism is not limited to the power transmission gear mechanism, and may be any known power transmission mechanism such as a power transmission mechanism composed of a pulley and an endless belt as long as it can be applied to the motor retractor.

In addition, the spring member 10 may be omitted as in the case of the seatbelt retractor disclosed in Japanese Unexamined Patent Application Publication No. 2005-35485.

What is claimed is:

1. A seatbelt retractor comprising:
a spool for retracting a seatbelt;
a motor for generating a drive torque for rotating the spool;
a power transmission mechanism for transmitting drive torque of the motor to the spool;
a cover for covering the power transmission mechanism; and
an operation noise restraint for restraining generation of operating noise when the power transmission mechanism is operated.

2. The seatbelt retractor according to claim 1, wherein the power transmission mechanism includes a gear and a revolving shaft on which the gear is mounted for rotation therewith, and
the operation noise generation restraint is a space set between the cover and the revolving shaft so that the revolving shaft avoids abutment with the cover.

3. The seatbelt retractor according to claim 1, wherein the power transmission mechanism includes a gear and a revolving shaft on which the gear is mounted for rotation therewith, and
the revolving shaft includes a movement preventing device for keeping the gear from moving axially along the revolving shaft for avoiding abutment between the gear and the cover.

4. The seatbelt retractor according to claim 3, wherein the movement preventing device comprises a groove of the revolving shaft and a ring-shaped stopper fitted to the groove.

5. A seatbelt retractor according to claim 1 in combination with the seatbelt for constraining a passenger, a tongue supported by the seatbelt so as to be capable of sliding thereon, and a buckle provided on a vehicle body or a vehicle seat so that the tongue can be engaged with the buckle.

6. The seatbelt retractor according to claim 1 wherein the power transmission mechanism includes a rotary shaft and gear thereon adjacent the cover, and the operation noise restraint comprises one of a space between the rotary shaft and the cover, and a stop for keeping the gear from engaging the cover as the gear and shaft are rotated.

7. The seatbelt retractor according to claim 6 wherein the operation noise restraint comprises both the space and the stop.

8. The seatbelt retractor according to claim 6 wherein the rotary shaft includes a free end adjacent the cover, and the space is between the free end of the shaft and the cover.

9. The seatbelt retractor according to claim 6 wherein the stop comprises a radially extending member fixed to the shaft between the gear and the cover.

10. A motorized seatbelt retractor comprising:
a rotatable spool having seatbelt webbing thereon;
a motor for generating drive torque to rotate the spool;
a power transmission between the motor and spool for transmitting the motor drive torque to the spool;
a rotary shaft of the power transmission;
a gear mounted on the rotary shaft for rotation therewith;
a cover that extends over the shaft and the gear;
a free end of the rotary shaft adjacent the cover; and
a noise avoidance system including one of a gap between the shaft end and the cover, and a stop between the gear and the cover, to respectively avoid noise generating contact between the shaft end and cover or the gear and the cover during rotation of the shaft and gear.

11. The motorized seat belt retractor of claim 10 wherein the noise avoidance system includes the gap to avoid noise generating contact between the shaft end and cover.

12. The motorized seatbelt retractor of claim 10 wherein the noise avoidance system includes the stop to avoid noise generating contact between the gear and cover.

13. The motorized seatbelt retractor of claim 10 wherein the noise avoidance system includes both the gap to avoid noise generating contact between the shaft and cover and the stop to avoid noise generating contact between the gear and cover.

14. The motorized seatbelt retractor of claim 10 wherein the stop comprises a radially extending member fixed to the shaft adjacent the end thereof.

15. The motorized seatbelt retractor of claim 14 wherein the shaft includes an annular groove adjacent the free end thereof, and the radially extending member includes a ring stopper mounted in the groove.
